(19) United States
(12) Patent Application Publication
(10) Pub. No.: US 2012/0181733 A1
(43) Pub. Date: Jul. 19, 2012

(54) LOW CARBON COATINGS AND SLIPS FOR MEMBRANE DEPOSITION

(76) Inventors: Brian L. Bischoff, Knoxville, TN (US); Curtis Jack Miller, Oak Ridge, TN (US)

(21) Appl. No.: 13/006,174

(22) Filed: Jan. 13, 2011

(51) Int. Cl. C04B 35/64; C08K 3/08

(52) U.S. Cl. 264/628; 524/440

(57) ABSTRACT

A metal powder slip composition includes a metal powder, a polycarbonate binder, and a liquid carrier. The slip composition can be debound after slip casting without generating residual carbon. The slip composition can be formed into a porous metal layer on a porous substrate object, the porous metal layer having low residual carbon content, without requiring a step of removing residual carbon. A corresponding method of making a porous metal layer is also provided.

### GOVERNMENT RIGHTS

This invention was made with government support under Contract No. DE-AC05-00OR22725 awarded by the U.S. Department of Energy. The government has certain rights in the invention.

### FIELD OF THE INVENTION

This invention is directed to a metal powder slip composition for membrane deposition which does not generate residual carbon during post-deposition removal of the binder and, therefore, does not require an oxygen heating cycle to remove carbon and other residues.

### BACKGROUND OF THE INVENTION

In a conventional metal powder slip casting process, fine metal powders are mixed with an organic binder and solvent to form a casting slip, which is used to coat a porous metal substrate with a thin membrane layer (herein referred to as a “slip cast layer” or “slip cast object”). Thermal processing is required to remove the binder and partially consolidate or sinter the applied layer so that it forms a continuous porous network. Temperatures in these processes are high enough to decompose the organic binders, leaving residual carbon. The residual carbon must then be removed at temperatures below about 800° C. At temperatures ranging from 815° C. to 950° C. carburization occurs, where the residual carbon becomes incorporated into the ferrous lattice of the slip cast layer and/or the porous metal article being coated. By exposing the coated metal article to oxygen or air in the range of 300 to 600° C., the residual carbon reacts with the oxygen to form carbon dioxide, and is thereby released from the slip cast layert.

Exposure of the slip cast layer to oxygen or air at these temperatures causes unwanted oxidation of the metal that forms the slip cast layer. The slip cast layer (often with the coated metal article) must then be processed in a reducing atmosphere to reverse the oxidation in order to produce the finished sip cast layer and coated metal article. In some instances, the oxidation is very difficult to reduce without treating at high temperatures that fully densify the slip cast layer. Without oxygen during heat treating, conventional binders leave an unwanted carbon residue in the applied slip cast layer. The residual carbon may be removed by heating to temperatures close to the melting point. If the article is intended to remain porous, this results in a non-porous article that is not fit for its intended use. Also, some membrane materials, when exposed to higher temperatures that are normally required to decompose common binders, are rendered unfit for use because they result in essentially non-porous structures.

In order to simplify the process for preparing slip cast layers and coated metal articles, there is a need or desire for a powdered metal slip composition that minimizes or eliminates the formation of residual carbon.

### SUMMARY OF THE INVENTION

The present invention is directed to a metal powder slip composition that can be debound without generating residual carbon, and a method of applying a cast porous metallic layer to a porous article.

The metal powder slip composition includes a metal powder, a polycarbonate binder, and a suitable liquid carrier. Because polycarbonate binders contain chemically bound oxygen, they can be thermally decomposed at moderate temperatures (typically about 320 C.) without leaving a carbon residue regardless of whether the surrounding atmosphere is inert, reducing or oxidizing. Cast metal articles made from the slip composition suitably have a carbon content no greater than the carbon content of the starting metal powder, without requiring an additional step for removing residual carbon.

The method includes the steps of mixing a metal powder with a polycarbonate binder and a liquid carrier to form a metal powder slip composition, casting the metal powder slip composition onto a porous substrate, solidifying the metal powder slip composition to form a slip cast object, debinding the slip cast object, and sintering the slip cast object to form a cast porous layer. Because no oxidation step is required for removing residual carbon, there is no resulting oxidation of the metal in the slip cast object, and no need for a reducing step.

With the foregoing in mind, it is a feature and advantage of the invention to provide a metal powder slip composition that does not generate residual carbon during debinding, and eliminates the need for the oxidation of residual carbon and the subsequent reduction of oxidized metal.

### BRIEF DESCRIPTION OF THE DRAWINGS

FIG. 1 is a schematic of one embodiment of the method of preparing a cast porous layer according to the invention.

### DETAILED DESCRIPTION OF THE INVENTION

The present invention is directed to a metal powder slip composition and method of fabricating a cast porous layer on a substrate article. The metal powder slip composition does not form significant residual carbon upon decomposition of its binder component, and suitably does not require a carbon removal step in order to produce the cast porous layer.

As used herein, the phrase “low carbon content” refers to a carbon content of less than about 0.1% by weight of the metal powder or slip cast object, suitably less than about 0.05% by weight, or preferably less than about 0.03% by weight. Suitably, the carbon content of the slip cast object is about equal to or less than the carbon content of the metal powder from which it is formed.

The metal powder slip composition includes about 40-98% by weight of a metal powder, suitably about 60-96% by weight, or about 80-95% by weight, based on a dry weight of the total solids in the slip composition. Suitable metal powders include without limitation nickel, stainless steel, tungsten, copper, and other iron and nickel alloys, and combinations thereof.

The metal powder slip composition includes about 2-60% by weight of a polycarbonate binder, suitably about 4-40% by weight, or about 5-20% by weight, based on a dry weight of the total solids in the slip composition. The term “polycarbonate binder” refers to binder polymers that include the following carbonate group as part of a repeating chemical structure.

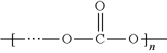

When polycarbonate binders thermally decompose, they release carbon dioxide and, in some instances, volatile organic compounds, but do not leave residual carbon. Polycarbonates can be prepared by reacting an aromatic difunctional phenol with phosgene or an aromatic or aliphatic carbonate. Various polycarbonates can be used as binders, including without limitation bisphenol P-type polycarbonates, bisphenol Z-type polycarbonates, copolymer-type polycarbonates of bisphenol P and bisphenol A, copolymers of a structural unit derived from benzophenone and a structural unit derived from diphenylmethane, and combinations thereof. For purposes of the invention, particularly suitable polycarbonate binders include poly(propylene carbonate) and poly(ethylene carbonate). The polycarbonate binder can have a weight average molecular weight of about 100,000 to about 350,000 grams per mole.

The metal powder, polycarbonate binder and any other solid ingredients (described below) are dispersed in a liquid carrier to obtain the desired viscosity. The final slip should be flowable but have enough viscosity to keep the metal particles suspended in the slip. The viscosity required for the coating process will be apparent to persons of ordinary skill in the art and desirably ranges between a viscosity of water and a viscosity of heavy oil, specifically about 1 centipoise to about 10,000 centipoise at ambient temperature. A desired viscosity of the slip may be maintained over time by adding liquid carrier to the slip because of the volatility of a preferred liquid carrier. The optimal liquid carrier may very depending upon the types and amounts of metal powder and binder. Suitable liquid carriers include without limitation water, tertiary butanol, butanol-2, amyl alcohol, acetone, ethanol, methanol, toluene, isopropanol, and combinations thereof.

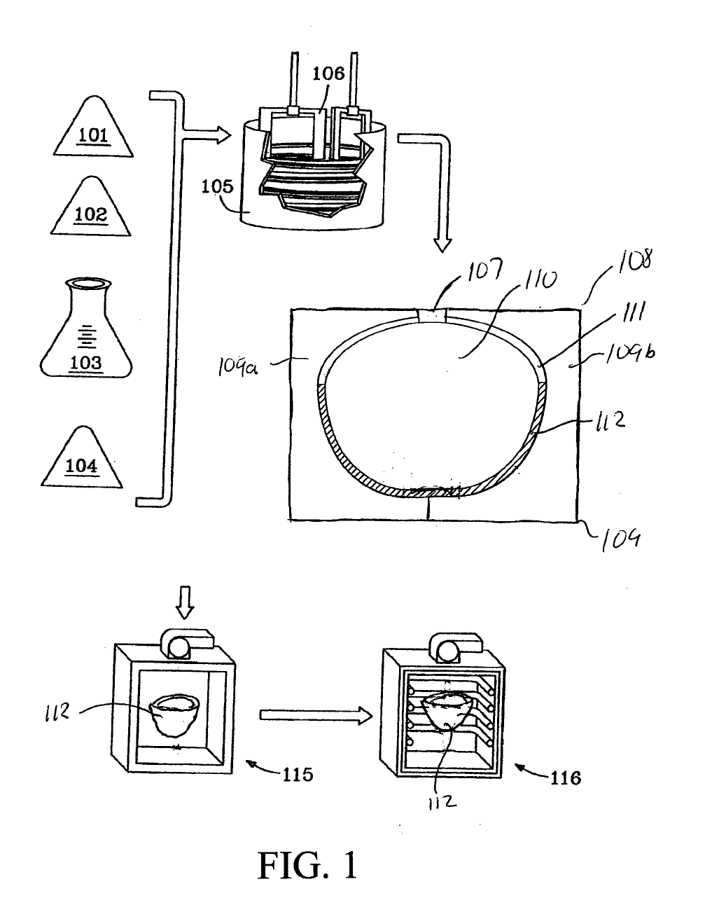

Referring to FIG. 1, the metal powder slip composition can be prepared by mixing a metal powder from source 101 with a polycarbonate binder from source 102 and a liquid carrier from a source 103 using a mixer 105 having impellers 106. Optional polymers, surfactants, sintering acids, lubricants and other additives can be added to the mixture, as needed, from source 104. The combined ingredients can be mixed together in mixer 105 at ambient or higher temperature for a suitable period of time, to form a uniform slurry as will be apparent to persons of ordinary skill in the art. Other suitable mixing techniques familiar to persons skilled in the art can also be employed.

The metal powder slip composition can be removed from the mixer 105 and cast into/on a porous body that will be the support for the membrane during use. The excess metal powder slip composition, if any, is allowed to pour out of the support body or is mechanically removed. The metal powder slip composition can be under pressure when in contact with the porous support to control the pressure differential from the coated side to the uncoated side of the support. The measurement of the pressure differential can be used to control the application of the coating.

The metal powder slip composition can be used to apply a slip cast layer to the inside or outside of any porous support. The porous support can be tubular or flat, or can have any suitable geometry. The metal powder slip composition can also be used to make a stand-alone slip cast object, such as by pouring it into a mold. In the exemplary embodiment of FIG. 1, the metal powder slip composition can be discharged from the mixer 105 and fed into an opening 107 of a slip casting mold 108. Slip casting molds, such as mold 108, can be used to make thin cast, shaped metal articles or cast metal coatings over solid objects. Mold 108 includes an outer mold part 109, defined by two half sections 109a and 109b, an inner mold part 110, and a mold space 111 between the mold parts 109 and 110.

At least one of the mold parts 109 and 110 is porous, and/or contains fine channels, capillaries or similar devices capable of receiving and removing liquid carrier from the metal powder slip composition, and perhaps some of the binder, without receiving any significant amount of metal powder. As the metal powder slip composition is discharged into mold opening 107, it is permitted to fill the mold space 108 to a desired level to form a slip cast object 112 having the desired dimensions. If the slip cast object 112 is intended to have a hollow interior, such as in a stand-alone article, then either the outer mold part 109 or the inner mold part 110, or both, can include the pores, capillaries or similar means of removing the liquid carrier. This can be accomplished by forming one or both mold parts with a disposable porous material such as plaster. The removal of liquid can also be accomplished by forming one or both mold parts from a permanent porous or capillary-filled metal and applying a vacuum to pull the liquid through the pores and capillaries.

If the slip cast object 112 is intended to serve as a porous metal layer for a substrate object, then the substrate object to be covered can serve as the inner mold part 110. In this case, the liquid carrier must be removed through pores or capillaries in the outer mold part 109 and the inner mold part 110 must be a durable material capable of withstanding the high temperatures of subsequent method steps.

The metal powder slip composition remains in the mold 108 at a time and temperature suitable to remove the liquid carrier and harden the slip composition to form the slip cast object 112. Depending on the size, shape and composition of the slip cast object 112, the slip composition can remain in the mold 108 indefinitely (if the mold defines all or part of a porous article being coated) or can be separated from the mold. Depending on the solvent, a minimum of 4-24 hours at room temperature or above may be required to sufficiently remove the solvent before subsequent processing.

The slip cast object 112 is then separated from the mold 108. If the mold 108 is formed entirely or partially from a disposable material, such as porous plaster, then the separation of the slip cast object 112 can be accomplished by breaking or other physical destruction of the mold 108. Where the outer portion 109 of mold 108 is formed of two half sections 109a and 109b as shown, the separation of the slip cast object 112 can be accomplished by opening and separating the half sections 109a and 109b.

At this stage, the slip cast object is in a green state, meaning the polycarbonate binder has not yet been removed. The slip cast object 112 (along with the coated propos article, if applicable) can then be fed to an oven or furnace 115, which performs a debinding step.

The debinding step removes the polycarbonate binder from the slip cast object 112 and is performed by heating the slip cast object 112 to a temperature of about 280 to about 360° C. at a rate of about 0.5° C. per minute to about 5° C. per minute. The feed rate to the oven or furnace 115 depends on the size of the heating chamber and should be sufficient to replace the chamber volume every 0.5 to 5 minutes. During the debinding step, the polycarbonate binder decomposes to carbon dioxide and, depending on the particular binder, volatile organic components. No residual carbon is left behind in the slip cast object 112, which leaves the debinder in a brown state.

The oven or furnace 115 may then have its temperature increased to a final sintering temperature. Alternatively, the slip cast object 112 (along with the porous article that is coated, if applicable) can then be fed to a sintering chamber 116 which performs a sintering step in order to sinter or consolidate the slip cast object 112 and maintain it as a coherent mass. The sintering can be performed by raising the temperature of the slip cast object 112 to between about 500 and about 1500° C., and maintaining that temperature for about 0.5 to about 2 hours. The sintering can be performed in stages and the temperature and atmosphere required depend on the material type, particle size and particle morphology of the metallic powder comprising the article. Most stainless steels melt at 1300-1500° C. and sinter at 800-1200° C. The sintering can be performed in an atmosphere of hydrogen, argon, nitrogen, vacuum, or another atmosphere that is free of oxygen and reactive impurities. The optimal sintering conditions will vary depending on the size and shape of the slip cast object 112 and its metal composition.

The metal powder used in the metal powder slip composition can have a carbon content of less than about 0.1% by weight, suitably less than about 0.05% by weight, or preferably less than about 0.03% by weight. The finished slip cast object can have a carbon content of less than about 0.1% by weight, suitably less than about 0.05% by weight, or preferably less than about 0.03% by weight. Suitably, the carbon content of the finished slip cast object is about equal to or less than the carbon content of the metal powder used in the slip composition.

In the embodiment where the slip cast object 112 is applied as a thin metallic porous layer to a porous substrate object, the slip cast object can be combined with the substrate object in the mold 108 or in a subsequent processing step. When the combination occurs in the mold 108, the inner mold part 110 can be the substrate object and, if desired, the mold space 111 can be completely filled with the metal powder slip composition so that it surrounds the substrate object. If the slip cast object is combined with the substrate object at any time prior to sintering, then the substrate object must be able to withstand the sintering conditions. Exemplary porous substrate objects include without limitation tubular objects, flat objects, and other objects having any suitable geometry. Specific examples include without limitation porous metals or ceramic tubes, such as where the slip composition is poured into the ceramic tube and then poured out and, where needed, excess slip composition is mechanically removed.

While there has been shown and described what are presently considered to be preferred embodiments of the invention, it will be apparent to those skilled in the art that various modifications and improvements can be made without departing from the scope of the invention as defined by the appended claims.

What is claimed is:

1. A metal powder slip composition, comprising:
about 40-98% by weight of a metal powder, based on a dry weight of total solids in the slip composition;
about 2-60% by weight polycarbonate binder, based on the dry weight of total solids in the slip composition, and
a liquid carrier, present in an amount such that the slip composition has a viscosity between about 1 centipoise and about 10,000 centipoise at ambient temperature.

2. The metal powder slip composition of claim 1, wherein the metal powder has a carbon content less than about 0.1% by weight of the metal powder.

3. The metal powder slip composition of claim 1, wherein the metal powder is selected from the group consisting of nickel, stainless steel, tungsten, copper, alloys of iron and nickel, and combinations thereof.

4. The metal powder slip composition of claim 1, wherein the polycarbonate binder is selected from the group consisting of bisphenol P-type polycarbonates, bisphenol Z-type polycarbonates, copolymer-type polycarbonates of bisphenol P and bisphenol A, copolymers of a structural unit derived from benzophenone and a structural unit derived from diphenylmethan, poly(ethylene carbonate), polypropylene carbonate), and combinations thereof.

5. The metal powder slip composition of claim 1, wherein the liquid carrier is selected from the group consisting of water, tertiary butanol, butanol-2, amyl alcohol, acetone, ethanol, methanol, toluene, ispropanol, and combinations thereof.

6. A method of fabricating a cast porous layer, comprising the steps of:
providing a metal powder slip composition including a metal powder, polycarbonate binder, and a liquid carrier;
casting the metal powder slip composition onto a porous substrate;
solidifying the metal powder slip composition to form a slip cast object;
debinding the slip cast object; and
sintering the slip cast object to form a cast porous layer.

7. The method of claim 6, wherein the debinding step does not form residual carbon and the method is devoid of an oxidation step to remove residual carbon.

8. The method of claim 6, wherein the metal powder has a carbon content less than about 0.10% by weight and the cast metal article has a carbon content less than about 0.10% by weight.

9. The method of claim 6, wherein the metal powder slip composition comprises:
about 40-98% by weight of the metal powder, based on a dry weight of total solids in the slip composition; and
about 2-60% by weight of the polycarbonate binder, based on the dry weight of total solids in the slip composition.

10. The method of claim 6, wherein the step of solidifying the metal powder slip composition comprises the steps of removing liquid carrier from the metal powder slip composition.

11. The method of claim 6, wherein the step of debinding the slip cast object comprises heating the slip cast object to a temperature of about 280 to about 360° C. at a rate of about 0.5° C. per minute to about 5° C. per minute.

12. The method of claim 11, wherein the step of debinding the slip cast object is performed in a furnace or oven.

13. The method of claim 6, wherein the step of sintering the slip cast object comprises heating the slip cast object to a temperature of about 500 and about 1500° C., for a period of about 0.5 to about 2 hours.

14. A method of forming a cast porous metal layer as a coating on a substrate object, comprising the steps of:
providing a metal powder slip composition including a metal powder, a polycarbonate binder, and a liquid carrier;
casting the metal powder slip composition onto the substrate object;
solidifying the metal powder slip composition to form a slip cast object on the substrate object; and
debinding the slip cast object.

15. The method of claim 14, wherein the step of casting the metal powder slip composition onto the substrate object is performed in a mold.

16. The method of claim 15, wherein the substrate object forms part of the mold and the metal powder slip composition is cast over the substrate object in the mold.

17. The method of claim 16, further comprising the step of separating the slip cast object and the substrate object from a remaining portion of the mold.

18. The method of claim 14, further comprising the step of sintering the slip cast object.

19. The method of claim 18, wherein the step of sintering is performed after the slip cast object is combined with the substrate object.

20. The method of claim 14, wherein the cast metal article has a residual carbon content less than about 0.1% by weight and the method is devoid of a step for removing residual carbon.
